(19) United States
(12) Patent Application Publication
(10) Pub. No.: US 2012/0326867 A1
(43) Pub. Date: Dec. 27, 2012

(54) System and method for sensing a gate tampering

(75) Inventors: Alex Parsadayan, Monarch Beach, CA (US); Wayne C. Hom, Coto De Caza, CA (US)

(73) Assignee: Maximum Controls, L.L.C.

(21) Appl. No.: 13/135,055

(22) Filed: Jun. 24, 2011

(51) Int. Cl. G08B 13/00

(52) U.S. Cl. 340/541

(57) ABSTRACT

A system and method for detecting a tampering of a moveable gate barrier. A singular or a plurality of vibration sensors are strategically positioned on the gate and a gate operator to detect tampering while the gate is closed. If the sensor outputs exceed preset thresholds of duration and/or magnitude, an alarm is activated to alert personnel to an attempted breach of the gate barrier.

### BACKGROUND OF THE INVENTION

1. Field of the Invention

This invention relates to the field of automatic moveable barriers or gates. More specifically, the invention relates to a system and method for detecting a tampering act upon a moveable barrier.

2. Background Art

Moveable barrier operators are automated systems which are utilized to move a barrier between a fully open position and a fully closed position. Some examples of moveable barriers are sliding gates, swing gates, barrier arms and overhead doors. A typical moveable barrier operator consists of a motor coupled to a drive train attached to the moveable barrier to move the barrier between open and closed positions.

Such powered moveable barrier operators are controlled by various inputs to initiate an open, close or stop command. Inputs usually consist of wired contact switches or wireless receiver units along with their respective transmitters or a combination of both.

Generally, such moveable barriers are installed to limit ingress and egress of vehicles and/or personnel to properties. Prior systems have utilized perimeter intrusion systems such as cameras, motion detectors, or magnetic sensors on the barriers themselves. All of these are intended to alert the property owner or resident if someone tries to breach the moveable barrier.

Cameras require constant monitoring; motion detectors are prone to false alarms from innocent passers by and magnetic sensors can register false alarms to misalignment or even from the wind vibrating or pushing against the barrier. In addition, all of the aforementioned devices require additional wiring to the moveable barrier operator or to the central alarm system.

### SUMMARY OF THE INVENTION

The present invention comprises a system and method for detecting a tampering act upon a moveable barrier. A circuit consisting of a sensor coupled to the moveable barrier controller is mechanically mounted in close proximity to the drive train that is coupled to the moveable barrier.

During normal operation of the moveable barrier when the barrier is moving from a fully open position to a fully closed position, the sensor output is monitored for excessively high shock (indicating a car crashing into the gate while the gate is opening or closing). A lower threshold is used when the gate is stopped. When the moveable barrier is in a fully stopped condition, the output of the sensor is monitored for excessive force or movement indicative of someone or something attempting to breach the integrity of the moveable barrier. When the sensor output exceeds a predetermined threshold in magnitude and/or time, the controller provides a signal that a breach is in process. This signal alerts the property owner, resident or activates a central alarm.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a front elevational view of a sliding barrier gate in which the present invention may be employed;

FIG. 2 is an elevational view of the drive train of the sliding barrier gate of FIG. 1 showing the addition of a sensor used in a preferred embodiment of the present invention; and

FIG. 3 is a block diagram of a gate tampering alarm system according to one embodiment hereof.

### DETAILED DESCRIPTION OF THE PREFERRED EMBODIMENTS

Referring now in more detail and by reference characters to the drawings which illustrate a preferred embodiment of the present invention 10 designates a gate operator shown with operative connections to a longitudinally shiftable gate 12, often referred to as a “sliding gate”. In this case, the gate 12 is shiftable from a closed position across an access opening to an open position and from the opened position to the closed position by means of the gate construction and, as such, does not form part of the present invention per se. The gate is conventionally provided with rollers 20 which are moveable along a track 22, the latter of which is fixed to the ground or other supporting surface.

In essence, gates of this type are used with security apartment buildings and similar commercial establishments and dwelling structures. The access opening permits passage of either people or vehicles and the gate can be shifted from the closed to the opened position for such access. Generally, many commercially available prior art gate operators use a radio frequency receiver-transmitter system, such that the party desiring to open the gate will actuate the transmitter to generate a radio frequency signal which causes a receiver to energize a motor for shifting the gate. The transmitter-receiver system of this type operates as a switch. In this respect, the apparatus of the present invention can be used with a key operated system or with the conventional radio frequency operated transmitter-receiver system.

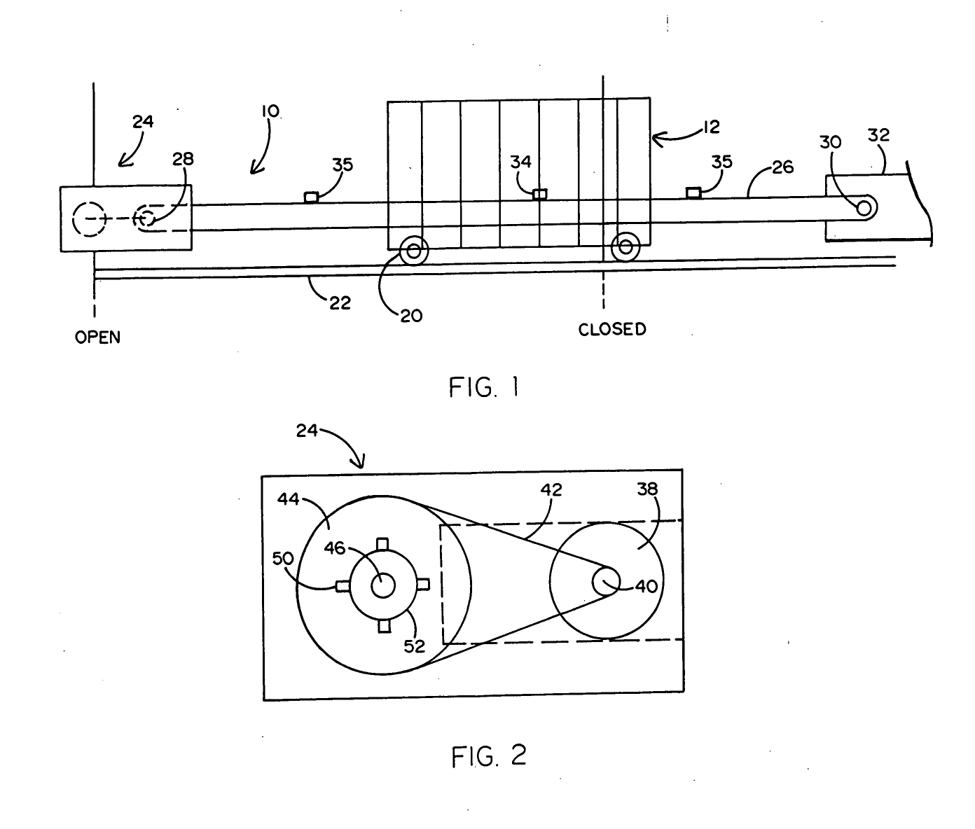

The gate 12 is connected to a gate operator 10 through a continuous drive chain 26. The drive chain 26 is positioned about a drive sprocket 28 located in an operator 24 and also about a similar idler sprocket 30 on a fixed structure 32. Further, the gate is attached to the drive chain by a suitable coupling 34, all as best shown in FIG. 1. The exact details of this drive arrangement, not including the details of the operator 12, are essentially conventional and therefore not described in any further detail herein. However, by reference to FIG. 1, it is to be noted that the gate 12 would move between a fully opened position where the left-hand end of the gate would be located at the line designed “OPEN” and would also be normally moved to a fully closed position, where the left-hand end of the gate 12 would reside at the line designated “CLOSED”.

The gate operator 10 includes an operator/drive mechanism 24, which is more fully illustrated in FIG. 2 of the drawings and comprises an electric drive motor 38, having a motor sprocket 40 connected thereto. A drive belt 42 is trained around the motor sprocket 40 and a similar sprocket 44. The sprocket 44 is mounted on a shaft 46 journaled in a fixed plate 48 forming part of the operator housing and is connected to a clutch (not shown).

In accordance with the construction of the operator/drive mechanism 24, as shown in FIG. 2, it can be seen that energization of the motor 38 will cause rotation of the drive sprocket 40 and the associated sprocket 44 through the drive belt 42. The left-end of the drive shaft 46 would be connected to the drive sprocket 28, which causes opening and closing movement of the gate 12.

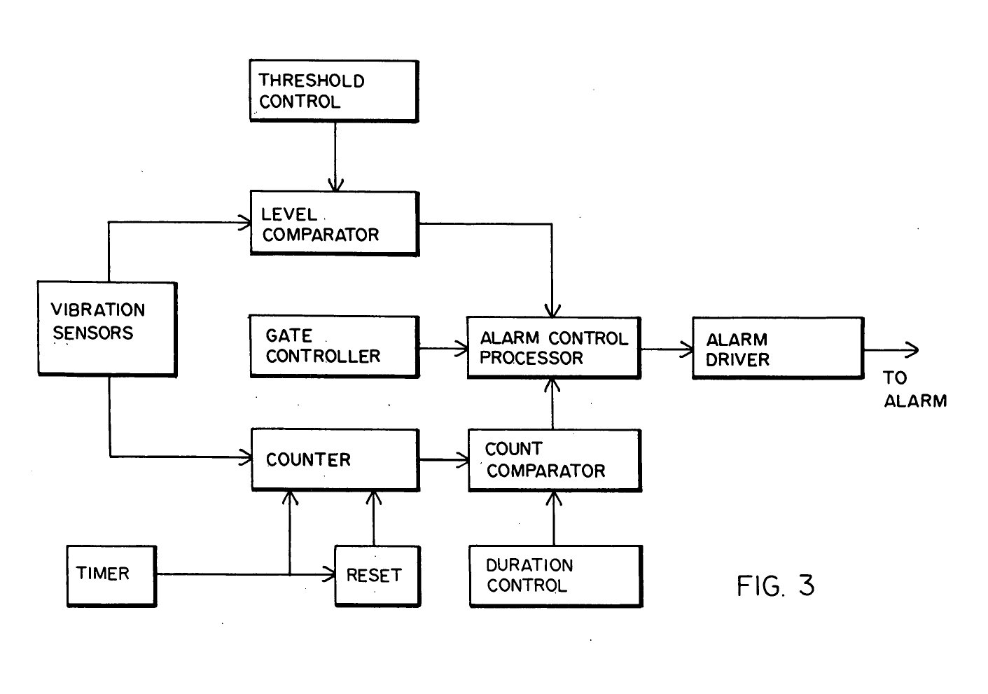

Sensing of an act of tampering is accomplished in the illustrated embodiment by strategically located vibration sensors or accelerometers 35 and 50. One pair of such sensors 35 are positioned on drive chain 26. Another set of sensors 50 are positioned on a disc 52 mounted to drive shaft 46 of operator/drive mechanism 24. FIG. 3 shows how the sensors are connected for activating an alarm based upon the magnitude and duration of their outputs when the gate operator is in a non-operational mode.

As seen in FIG. 3, one output of the vibration sensors is connected to a level comparator another input to which is a threshold control output. Another output of the sensors is connected to a counter which receives a timer signal. The output of the counter is connected to a count comparator, which also receives a duration control count. Both comparators are connected to an alarm control processor, which activates an alarm driver when the output of the vibration sensors exceeds a preset magnitude threshold and/or a preset duration control count. The alarm control processor also receives an input from the gate controller so that the alarm can distinguish a mode when the gate is in a non-operation mode such as when the gate is closed.

It will now be apparent that what has been disclosed herein comprises a tampering detection system for use with automatic barrier gates. The system in a preferred embodiment employs a plurality of vibration sensors or accelerometers. When an act of tampering occurs, the sensor outputs will activate an alarm if either their duration or intensity or both exceed preset thresholds. Although the disclosed embodiment is shown deployed on a slide gate, it will be understood that the present invention may be used on other types of automatic barrier gates. Accordingly, the scope hereof should be deemed to be limited only by the appended claims and their legal equivalents and not by the particular disclosed embodiment.

We claim:

1. A method of detecting a breach or tampering of an automatic moveable barrier comprising a controller and at least one vibration sensor including the steps of:
reading the output of the at least one vibration sensor;
analyzing the magnitude and duration of the sensor output;
determining if the sensor output indicates a breach or tampering of the moveable barrier by whether it exceeds present thresholds; and
sending a signal indicating a breach or tampering of the moveable barrier if it does exceed such preset thresholds.

2. The method of claim 1 where the determination of a breach or tampering of the moveable barrier is based on the duration of the sensor output.

3. The method of claim 1 where the determination of a breach or tampering of the moveable barrier is based on the magnitude of the sensor output.

4. The method of claim 1 where the determination of a breach or tampering of the moveable barrier is based on both the duration and the magnitude of the sensor output.

5. A system for detecting a breach or tampering of the moveable barrier comprising a controller, at least one vibration sensor, and an alarm for signaling the occurrence of a breach or tampering of the moveable barrier; said vibration sensor being mechanically coupled to said moveable barrier for responding to a mechanical force applied to said barrier in an attempt to overcome said barrier.

6. The system of claim 5 where the controller is integral to the moveable barrier operator.

7. The system of claim 5 where the controller is independent to the moveable barrier operator.

8. The system of claim 5 where the sensor is an accelerometer.

9. The system of claim 5 where the sensor is a piezo-electric transducer.

10. The system of claim 5 where the sensor is a load cell.

11. The system of claim 5 where the alarm for signaling the occurrence of a breach or tampering of the moveable barrier is sent through connecting wires.

12. The system of claim 5 where the alarm for signaling the occurrence of a breach or tampering of the moveable barrier is sent wirelessly through a wireless transceiver.
